(19) United States
(12) Patent Application Publication
(10) Pub. No.: US 2005/0279273 A1
(43) Pub. Date: Dec. 22, 2005

(54) Automobile instrument

(76) Inventor: Chi-Hsiang Pa, Yung He City (TW)

Correspondence Address: LEONG C LEI, PMB # 1008, 1867 YGNACIO VALLEY ROAD, WALNUT CREEK, CA, 94598, US

(21) Appl. No.: 10/868,212

(22) Filed: Jun. 16, 2004

(51) Int. Cl. G01D 11/24

(52) U.S. Cl. 116/305

(57) ABSTRACT

An improved construction of an automobile instrument comprised of a housing and a decorative rim; threads are provided on the outer circumference at the front of the housing and a gradation on the inner circumference; the decorative rim being provided with multiple slots in shuttle shape in a curved section of the outer circumference of the decorative rim and threaded inner circumference; a dial and a circuit board being placed in the housing, a pane being placed on the gradation, and the decorative rim being placed at the front of the housing for the instrument to be mounted on the motor car and the decorative rim can be replaced with one with different color as desired since the decorative rim and the housing are merely locked to each other.

### BACKGROUND OF THE INVENTION

(a) Technical Field of the Invention

The present invention is related to an automobile instrument, and more particularly, to one that can have varied colors according to the user's preference.

(b) Description of the Prior Art

Instruments including speedometers and tachometers are usually provided in a motor vehicle to display digits of speed and rpm. An instrument of the prior art as illustrated in FIG. 1 of the accompanying drawings is essentially comprised of a housing 11 provided with a flange 111, a pane 14 attached to the front end of the house 11 once a dial 12 and a circuit board 13 are placed into the housing 11 before covering up with a decorative rim 15 riveted to the front end of the housing 11. The assembly of the instrument secured in place with the decorative rim 15 looks dull in appearance and does not suit the style of the vehicle. It is also impossible for the car owner to choose the color of the instrument according to his/her particular preference.

### SUMMARY OF THE INVENTION

The primary purpose of the present invention is to provide an improved construction of an automobile instrument that allows a change of the decorative rim into different colors as desired to make the instrument colorful and to match the interior trim of the car and the personal preference of the car owner.

To achieve the purpose, the present invention includes a housing and a decorative rim, wherein, threads are provided on the outer circumference at the front of the housing, and a gradation on the inner circumference. The decorative rim has a threaded inner circumference to engage the housing after the dial and the circuit board are placed in the housing. Once the instrument is mounted on the instrument panel, the decorative rim can be replaced with another one in a different color as desired by the car owner.

Multiple slots in a shuttle shape are arranged in a curved section on the outer circumference at the front of the decorative rim to facilitate removing or mounting the decorative rim by hand without depending on any tool.

Furthermore, the decorative rim can be made of any type of material in any color to make it more colorful.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an automobile instrument of the prior art.

FIG. 2 is an exploded view of a preferred embodiment of the present invention.

FIG. 3 is a perspective view of the preferred embodiment of the present invention.

FIG. 4 is a sectional view of the preferred embodiment of the present invention.

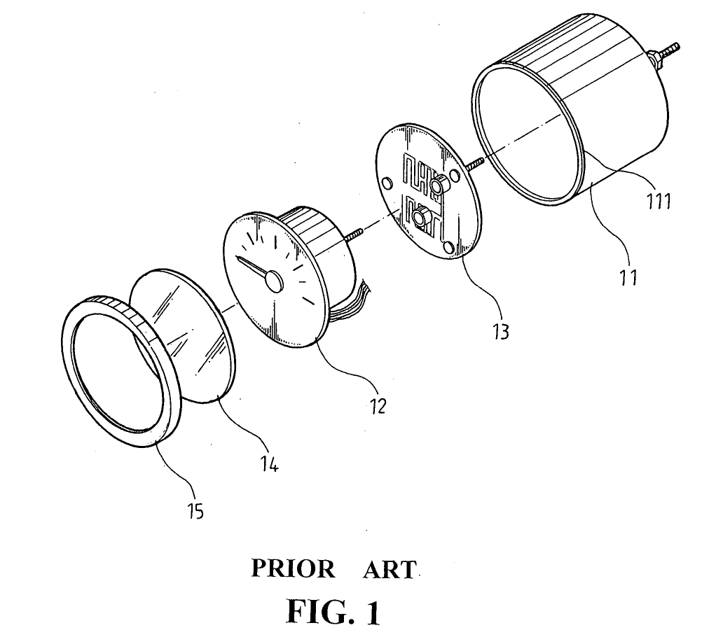

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

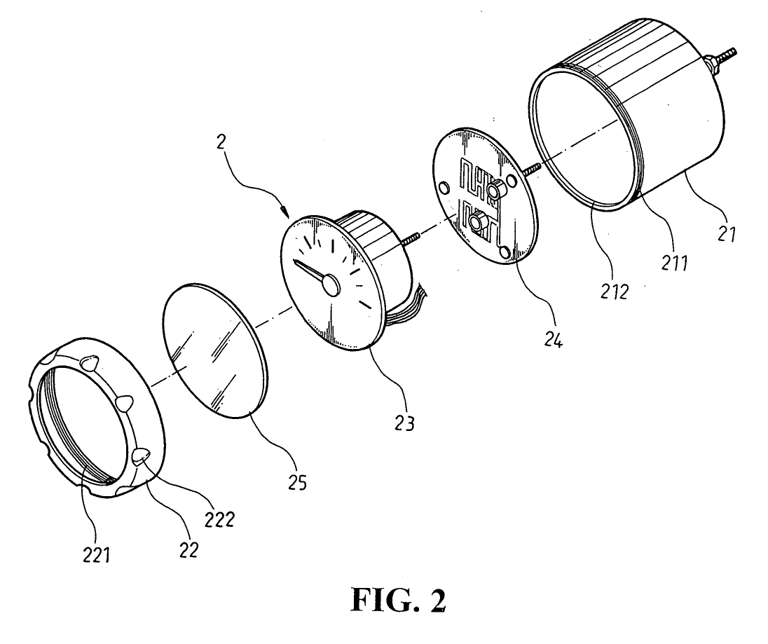

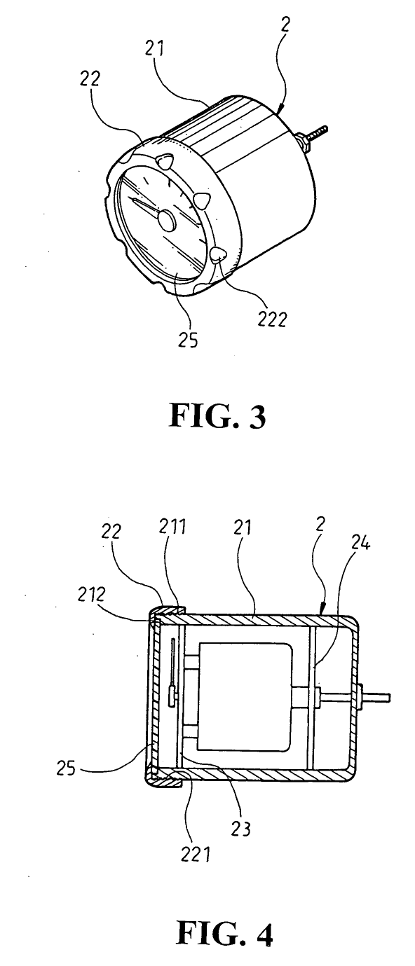

Referring to FIGS. 2 and 3, a preferred embodiment of the present invention is essentially comprised of a housing 21 and a decorative rim 22. The housing 21 indicates approximately a cylinder shape provided with multiple threads 211 on the outer circumference at the front and a gradation 212 on the inner circumference.

The diameter of the decorative rim 22 is slightly grater than that of the housing 21 while multiple threads 221 in relation to those threads 211 on the housing are provided on the inner circumference while multiple slots 222 in shuttle shape are arranged on a curved section at the front of the outer circumference.

An instrument dial 23 and a circuit board 24 are placed in the housing 21; a pane 25 is secured on the gradation 212 of the housing, and the decorative rim 22 is fixed to the housing by having its threads 221 engaged to those threads 211 on the housing 21 for the instrument to be mounted on the motor car or motorcycle.

Whereas the decorative rim 22 is locked to the housing 21 by threads, it can be replaced with another decorative rim of different colors or materials to match the style of the interior trim. Multiple slots 222 on the outer circumference of the decorative rim 22 allows easy holding by the hand to remove or mount the decorative rim 22 from or on the housing 21 without depending on any tool.

Now referring to FIG. 4, the dial 23 and the circuit board 24 are placed inside the housing 21, and the pane 25 is secured at where between the gradation 212 of the housing 21 and the decorative rim 22 to hold the pane 25 firmly in place. Upon replacing the decorative rim 22, simply remove it from the housing 21 and mount another decorative rim 22′ of different material or color to allow the instrument 2 more colorful for achieving better looks to the style of the interior trim of a motor car or to the appearance of a motorcycle, thus to upgrade the practical value of the instrument.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. (canceled)

2. An automobile instrument comprising:
a cylindrical housing having an outer circumference provided with a plurality of threads, and an inner circumference provided with a gradation; and
a decorative rim having a diameter which is slightly greater than a diameter of said housing, said decorative rim having an inner side provided with a plurality of threads adapted to engage with said threads of said cylindrical housing, said decorative rim having an outer circumference having a curved corner formed with a plurality of slots;
a circuit arranged with said housing;
an instrument dial mounted within said housing and installed on said circuit; and
a pane secured to said gradation.
